(19) United States
(12) Patent Application Publication
(10) Pub. No.: US 2009/0024805 A1
(43) Pub. Date: Jan. 22, 2009

(54) System, method and computer-readable medium for enabling access to additional memory capacity

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 11/879,213

(22) Filed: Jul. 16, 2007

(51) Int. Cl. G06F 13/28

(52) U.S. Cl. 711/153; 711/E12.002

(57) ABSTRACT

A method, system and computer-readable media for exchanging information via an electronics communications are provided. A computer includes a memory and an access logic are bi-directionally communicatively coupled with a controller. The memory includes an open memory area and a partitioned memory area, wherein the open area available is for use by the controller upon an initial sale, installation or start-up. The access logic is configured to enable access to the partitioned memory by the controller after a receipt by the access logic of an access purchase confirmation. The computer may be coupled with an electronics communications network, such as the Internet, and the access purchase confirmation may be delivered via the electronics communications network. The access to partitioned area may optionally be enabled on a temporary or a segmented basis.

### FIELD OF THE INVENTION

The present invention relates to information technology that enables the use of memory capacity. The present invention more particularly relates to information technology systems and methods that comprise or provide methods to enable access to or application of memory capacity of an information technology system.

### BACKGROUND OF THE INVENTION

Consumer electronic devices, such as personal computers, personal digital assistants and digital telephones, are typically advertised for sale as having a specific amount of memory capacity. For example, Apple Corporation of Cupertino, Calif. presently advertises and markets a personal computer model MacBook(™) personal computer as a standard product having a memory storage capacity of one gigabyte upon purchased and that may be expandable to two gigabytes of memory capacity. The expansion of the MacBook memory capacity from one gigabyte to two gigabytes is usually accomplished by (a.) a customer or user purchasing an additional memory capacity when ordering or selecting the MacBook from a direct sales agent; or (b.) acquiring an additional second gigabyte memory module and installing the additional memory module into the MacBook after purchase.

Many consumer electronic devices are sold with more memory capacity than the products are advertised or represented by a sales agent as having. The purchaser therefore often receives more capacity than he or she is paying for. There is therefore an opportunity to increase revenue to the marketer or manufacturer of certain consumer electronic devices to provide access to the additional memory capacity on a fee or purchase basis, wherein the additional memory capacity is defined as a memory capacity of an electronic device that is in excess of the memory capacity that is promised to the purchaser or user by purchase or acquisition of the device.

In addition, the cost to a manufacturer of adding memory capacity to an electronic device during device production is typically much lower than the cost of adding memory modules to a device in an after purchase transaction and installation. The manufacturer of many consumer electronic devices are thereby in a cost competitive position to install additional memory capacity in a consumer electronic device, and then offer access to the additional memory capacity at a lower cost than vendors that sell and install memory modules in an action occurring after a purchase of the electronic device. In addition, the process of enabling access to a previously installed memory module may be affected in ways that are more convenient to the consumer than the purchase and installation process of memory modules in the field.

The prior art includes United States Patent Application Publication No. 20050102232 discloses a host device, memory card, memory capacity changing method, memory capacity changing program and memory capacity charge giving/receiving method; United States Patent Application Publication No. 20030040962 discloses a system and data management and on-demand rental and purchase of digital data products; United States Patent Application Publication No. 20060047954 discloses a data access security implementation using the public key mechanism; U.S. Pat. No. 7,191,941, by Mollett, et al., issued on Mar. 20, 2007 presents systems and methods for determining a need for authorization; and U.S. Pat. Nos. 6,935,559, by Mollett, et al., issued on Aug. 30, 2005 teaches of systems and methods for determining an authorization threshold.

Each and every other patent and patent application, including U.S. Pat. No. 6,935,559; U.S. Pat. No. 7,191,941; US Patent Application Publication No. 20050102232; United States Patent Application Publication No. 20030040962; and United States Patent Application Publication No. 20060047954 mentioned in this disclosure is incorporated by reference in its entirety and for all purposes in the present patent application and this disclosure.

There is therefore a long felt need to enable a computational device user to easily remove or delete software from a computational device.

### SUMMARY OF THE INVENTION

Towards this object and other objects that will be made obvious in light of this disclosure, the method of the present invention provides methods and computational systems that include or provide an electronic device that enables access to an additional memory capacity. The electronic device, hereafter “computer” includes a controller, a memory, and an access logic. The memory and the access logic are bi-directionally communicatively coupled with the controller. The memory includes an open memory area and a partitioned memory area, wherein the open area available is for use by the controller upon an initial sale, installation or start-up. The access logic is configured to enable access to the partitioned memory by the controller after a receipt by the access logic of a key or an access purchase confirmation. The access logic may be comprised within a secure first application program, wherein the secure first application program is comprised within the computer and contains data access logic operable to enable the controller to access the partitioned memory. Alternatively or additionally, the access logic may be comprised within a structure of a logical device, a firmware or a reprogrammable electronic logic device.

It is understood that the computer may be or comprise a personal computer, a digital personal digital assistant, a digital cellular telephone, or other suitable device known in the art.

The computer may further include a network interface module, wherein the network interface module bi-directionally communicatively couples the controller with an electronics communications network, and the access purchase confirmation may be delivered via the network interface module and to the access logic. The communications network may be or include the Internet, an intranet, an extranet, a computer network, or a telephony system.

Alternatively or additionally, the computer may further include a user interface module that is bi-directionally communicatively coupled with the controller, and the access purchase confirmation may be delivered via the user interface module.

A first preferred embodiment of the method, or first method, enables access to an additional capacity of a memory of the computer by a local or remote server. The first method may include the aspects of (a.) reception by the server of an authorization for the computer to enable access to the additional capacity of the memory; and (b.) transmission of an access command to a controller of the computer to enable access to the additional capacity of the memory by the computer. In accordance with the first method, and alternatively or additionally, the computer and the server may be bi-directionally communicatively coupled by means of the Internet, an intranet, an extranet, a computer network and a telephony system.

In certain alternate preferred embodiments of the method of the present invention, the computer may include a user input module, wherein the user interface module is bi-directionally communicatively coupled with the controller, and authorization for the computer to enable access to the additional capacity of the memory may be delivered via the user interface module. In addition, an access command to the controller of the computer to enable access by the computer to the additional capacity of the memory may be derived from the authorization provided via the user input module to the controller.

Certain still alternate preferred embodiments of the method of the present invention may optionally, alternatively or additionally include various aspects, to include (a.) enabling to access a primary area of the memory when or before the computer is purchased; (b.) advertising the computer for sale as providing access to the primary area of memory; (c.) informing a user when the computer's operation is degraded by delays or other difficulties due to a memory capacity constraint; (d.) enabling access to a first portion of the additional capacity of the memory by the computer upon receipt of a first access command; (e.) enabling access to a second portion of the additional capacity of the memory by the computer upon receipt of a second access command; (f.) and/or enabling temporary access to a first portion of the additional capacity of the memory by the computer upon receipt of a first access command, e.g., ninety days.

Certain yet alternate preferred embodiments of the method of the present invention may optionally, alternatively or additionally include various aspects, to include (a.) notifying a user is that the computer has access to additional capacity is limited to a set time period; (b.) informing the user about how to purchase access rights to the additional capacity of the memory; offering access rights to the additional capacity of the memory for purchase at a discounted price for a set time period after an access command is issued in response to a determination by the computer that the computer requires more memory than the primary area; issuing the access code upon a first occasion that the computer's operation is degraded by delays due to a memory capacity constraint.

Certain yet other alternate preferred embodiments of the method of the present invention provide a computer-readable media comprising software-encoded instructions that direct an information technology network to practice one or more of the aspects of the method of the present invention as disclosed herein.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is an illustration of a prior marketing and sales process for increasing the memory capacity of an electronic device, such as a cellular phone, a personal digital assistant or a personal computer;

FIG. 2 is an illustration of a marketing and sales process that incorporates the first preferred embodiment of the method of the present invention, or first method, in the use of the electronic device of FIG. 1;

FIG. 3 is schematic diagram of an electronic device useful in implementing the first method of FIG. 2 and that enables the partitioning of a system memory into a primary memory and a partitioned memory, and further permits access to each of a plurality of segments of the partitioned memory 8 on a permanent or temporary basis;

FIG. 4 is an illustration of a first software program that directs the electronic device to act in accordance with the first method of FIG. 2;

FIG. 5 is an illustration of an electronic communications network comprising the electronic device of FIG. 3 and a server, the server enabling access to a partitioned memory of the electronic device; and

FIG. 6 is an illustration of a second alternate preferred embodiment of the method of the present invention, hereafter “second method”.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

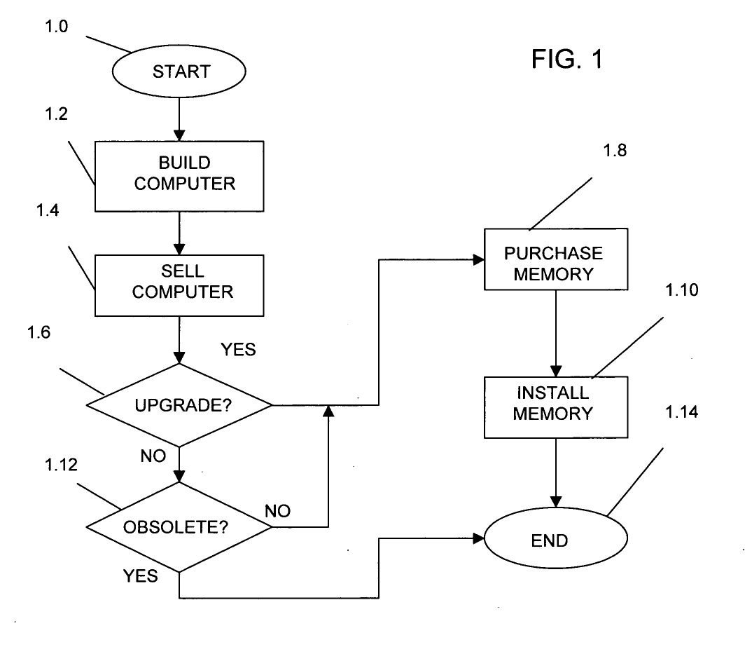

Referring now generally to the Figures and particularly to FIG. 1, FIG. 1 is an illustration of a prior marketing and sales process for increasing the memory capacity of an electronic consumer device, such as a cellular phone, a personal digital assistant or a personal computer. In step 1.2, a prior art device is built according to a bill of materials that provide a specified memory capacity. In step 1.4 the device is sold with a warranty of having either the specified memory capacity of step 1.2, or some lesser memory capacity. In step 1.6, and after purchase, a user may elect to upgrade the device by increasing the memory capacity of the device. The user selects and purchases a memory module in step 1.8 and installs, or has the memory module installed in step 1.10. The user may elect to obsolete the device in step 1.12 and proceed to end the life cycle of the device in step 1. 14, or alternatively proceed from step 1.12 to step 1.6 and reconsider upgrading the device.

The user's inconvenience and additional cost and time burden of the prior art method of FIG. 1 include (a.) taking the time to identify a preferred memory module; (b.) finding and selecting a memory module vendor; (c.) purchasing a memory module; (d.) arranging waiting for delivery of a memory module; (e.) deciding whether to install the memory module by himself or herself, or engaging a third party to install the memory module; and (e.) making a hardware installation of the memory module.

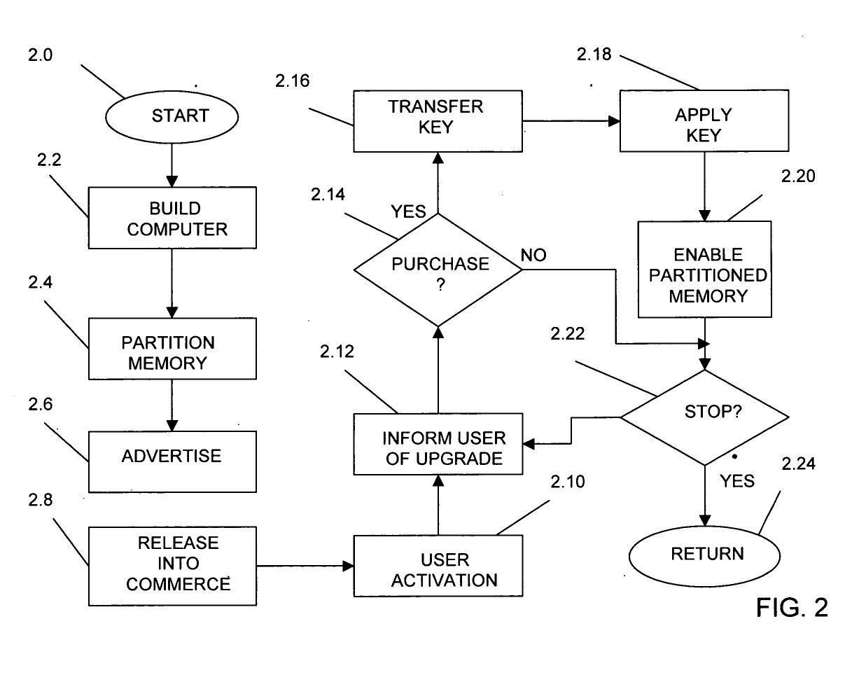

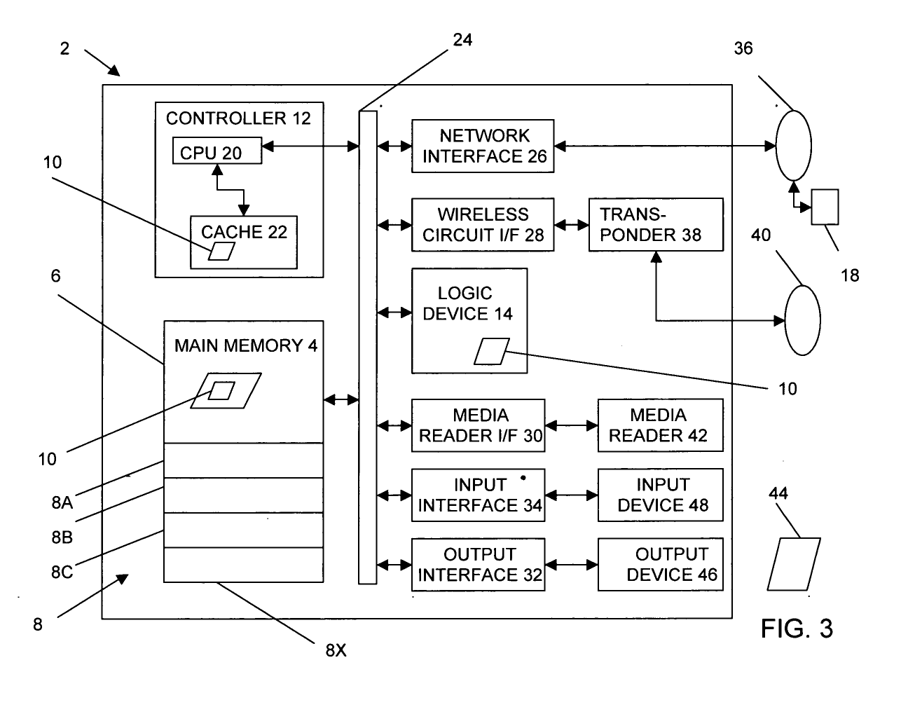

Referring now generally to the Figures and particularly to FIG. 2, FIG. 2 is an illustration of a marketing and sales process that incorporates the first preferred embodiment of the method of the present invention. In step 2.2 a computer 2, configured as discussed below regarding FIG. 3, is built. In step 2.4 a main memory 4 of the computer 2 is partitioned into a primary memory 6 and a partitioned memory 8. The partitioning may be affected by programming, or including within, the computer 2 with a memory management access logic 10, or “access logic” 10. Access is enabled in step 2.2 to the primary memory 6 by a controller 12 of the computer 2. Access is denied to the controller 12 to the partitioned memory 8 by the access logic 10 until certain conditions are met, e.g., receipt of a purchased authorization by the computer 2. Machine-readable software encoded instructions that direct the computer 2 to enable the access by the controller 12 may be provided to the computer 2 in steps 2.2 or step 2.4 as the access logic 10 and read into a system memory 4 of the computer 2 or as structured in a logic device 14. The logic device 14 may be a permanently logically structured electronic device, a firmware, a programmable logic device, or a reprogrammable logical device. Optionally, alternatively or additionally, the access logic 10 may be in whole or in part comprised with in the computer 2 (1.) as the dedicated logic device 14 that may be reprogrammable; and/or (2.) machine-readable software encoded instructions that are stored within the controller 12 and/or the main memory 4 of the computer 2.

In step 2.6 the computer 2 is advertised or warranted as providing the memory capacity of, or less than, the memory capacity of the primary memory 6. In step 2.8 the computer 2 is released into the stream of commerce. A user, e.g., a purchaser or owner of the computer 2, activates the computer 2 in step 2.10, wherein the computer 2 has access to the primary memory 6 but is denied access to the partitioned memory 8. In step the 2.12 the user is informed that a capability to use all or some of the partitioned memory 8 may be purchased on a permanent or temporary basis. In step 2.14 the user elects to purchase or not purchase access to the partitioned memory 8. In step 2.16 a message is generated and delivered to the user, optionally containing a password or key in response to a purchase request by the user. In step 2.18 the message of step 2.16 or the password or key of the message of step 2.16 is applied to the computer 2 and provided to the access logic 10. The access logic 10 processes the information received in step 2.18 and, if the information matches the access conditions of the access logic 10, the access logic enables access by the computer 2 to the partitioned memory 8.

In step 2.22 the process of FIG. 2 may be determined to be halted by (1.) user and/or (2.) a commercial provider of access to the partitioned memory 8. The process of FIG. 2 may be halted, for example but not limited to, after purchase by the user of access to all of the memory capacity of the main memory 4. When in step 2.22 the computer 2 determines not to halt the process of FIG. 2, the computer proceeds from step 2.22 to step 2.12. Alternatively, when the computer 2 determines in step 2.22 to halt the process of FIG. 2, the computer proceeds from step 2.22 to step 2.24, and wherein the process of FIG. 2 is halted.

The advantages of the first method over the prior art includes (a.) a lower cost of providing the additional memory capacity during an initial build of the computer 2 versus performing an after-purchase hardware upgrade; (b.) risk reduction to the user by providing compatible memory and avoiding the possibility of the user purchasing incompatible memory devices; (c.) ease of affecting a memory capacity upgrade by the user; and (d.) lower cost of sales by the manufacturer or other commercial sales agent in communicating with user and affecting access to additional memory capacity.

The access logic 10 may be comprised within (1.) a self-consistent sequence of steps that can be performed the programmable computer 2 under the direction of machine-readable software-encoded logic of a first software application 16, (2.) the logic device 14 containing specialized electronics logic or other circuitry; or (3.) a combination thereof that lead to the desired result of enabling access by the computer 2 to the partitioned memory 8 after purchase of access rights by a user. These steps can be defined by one or more computer instructions. These steps can be performed by a computer executing the instructions that define the steps. Further, these steps can be performed by circuitry designed to perform the steps. Thus, the term “access logic” can refer (for example, but without limitation) to a sequence of instructions, a sequence of instructions organized within a programmed-procedure or programmed-function, a sequence of instructions organized within programmed-processes executing in one or more computers, or a sequence of steps performed by electronic or other circuitry, or any other suitable logic known in the art.

In a preferred embodiment, a server 18 contains a key or password and the first application program contains data access logic operable to enable the controller 12 to employ the partitioned memory 8 in computational operations upon receipt by the computer 2 of the key or password. In particular, the access logic 10 may include authorization logic comprising instructions operable to cause the computer 2 to compare the key or password received from the server 18 with an access condition, and to enable access by the controller 12 to the partitioned memory 8 when the key or password matches the access condition. The access logic 10 may, in certain still additional alternate preferred embodiments of the method of the present invention, enable access by the controller 12 to a portion of the partitioned memory 6 and/or enable access by the controller 12 on temporary basis or on a no-charge trail period basis.

The computer 2 and server 18 may be or comprise (1.) a SUN SPARCSERVER computer workstation marketed by Sun Microsystems of Santa Clara, Calif. running LINUX or UNIX operating system; (2.) a personal computer configured for running WINDOWS XP™ operating system marketed by Microsoft Corporation of Redmond, Wash.; or (3.) a MacBook Pro™ personal computer as marketed by Apple Computer of Cupertino, Calif.

It is understood that the terms “key” and “password” as defined within this disclosure are synonymous and include a string of characters that a user must provide to the access logic 10 or the computer 2 gain access to a resource that is password-protected, e.g., the partitioned memory 8. It is further understood that the access logic 10 may be programmed or configured to require receipt of a key or a password in only one instance in order to enable (a.) access to a portion of the partitioned memory 8 without further limitation, constraint or requirement; (b.) continued access by the controller 12 to the partitioned memory 8 for a specified time period but without further constraint or requirement; or (c.) continued access by the controller 12 to the partitioned memory 8 for without any further constraint or requirement.

Referring now generally to the Figures and particularly to FIG. 3, FIG. 3 is an illustration of the computer 2 that enables the partitioning of the main memory 4 into the primary memory 6 and the partitioned memory 8, and further permits access to each of a plurality of segments 8A-8X of the partitioned memory 8 on a permanent or temporary basis. The controller 12 includes a central processing unit 20 bi-directionally communicatively coupled with a cache memory 22. An internal communications bus 24 further bi-directionally communicatively couples the central processing unit 20 (hereafter “CPU” 20) with the main memory 4, a network interface device 26, a wireless interface device 28, the logic device 14, a media reader interface 30, an output device interface 32, and an input device interface 34.

The access logic may be comprised wholly or partly, within the logic device 14, the cache memory 22 of the controller 12, and/or the first application software 16 and stored in the main memory 4 in various alternate preferred embodiments of the first method. The network interface device 26 is bi-directionally communicatively coupled with an electronic communications network 36. The wireless interface device 28 is bi-directionally communicatively coupled with a wireless communications transponder 38, whereby the computer 2 may be configured to communicate via a wireless telephony system 40.

The media reader interface 30 is bi-directionally communicatively coupled with a media reader 42, whereby the computer 2 may be configured to read machine-readable software-encoded information and instructions from, and optionally write machine-readable software-encoded information and instructions to, a computer-readable media 44. The media reader 42 is configured and matched with the computer-readable media 44 to enable reading machine-readable software-encoded information and instructions by from the media 44 and to the computer 2, and optionally for writing machine-readable software-encoded information and instructions from the computer 2 and to the media 44.

The output interface device 32 is bi-directionally communicatively coupled with an output device 46. The output device 46 may be or comprise a video screen and/or an audio output device.

The input interface device 34 is bi-directionally communicatively coupled with an input device 48. The input device 48 may be or comprise a a digital keyboard and/or a computer mouse. The input device 48 enables the user to input information and instructions to the computer 2, to include a key K1 for processing by the access logic 10.

In various alternate preferred embodiments of the first method, providing the key K1 to the access logic 10 enables access by the controller to the partitioned memory 8, to include access to one or more of the memory segments 8A-8X. The key K1 may be provided (1.) from the server 18 via the electronics communications network 36; (2.) via the telephony network 40; and/or from the computer-readable memory 44.

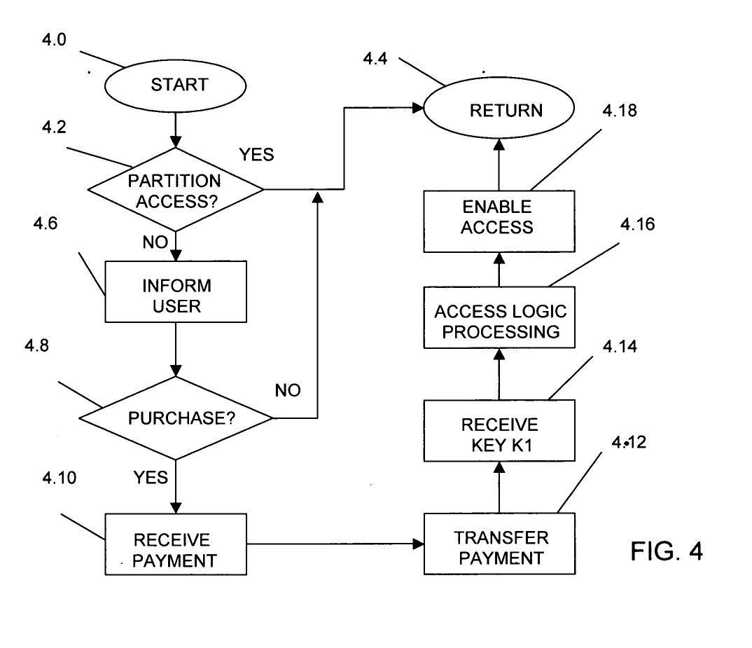

Referring now generally to the Figures and particularly to FIG. 4, FIG. 4 is an illustration of a first software program 50 that directs the computer 2 to act in accordance with the first method. The computer 2 is powered up in step 4.0. The controller 12 determines in step 4.2 whether the controller has access to the partitioned memory 8. When the controller 12 is determined in step 4.2 to have access to the partitioned memory 8, the computer 2 proceeds on from step 4.0 to execute step 4.4 and proceed to other operations, wherein the computer 2 may use the primary memory 6 and the partitioned memory 8 in executing computational operations, to include communication processes. When the controller 12 is determined in step 4.2 to not have access to the partitioned memory 8, the computer 2 proceeds on from step 4.0 to execute step 4.6 and inform the user via the output device 46 that access to the partitioned memory 8 may be purchased. The computer determines in step 4.8 whether the user is requesting to purchase access to the partitioned memory 8. In step 4.10 the computer 2 receives the payment information from the user, and in step 4.12 the computer 2 transmits the payment information to the server 18. In step 4.14 the computer 2 receives the key K1 from the server 18 via the electronics communications network 36 and/or the telephony network 40. In step 4.16 the access logic 10 processes the key K1 and, if the key K1 is determined to be valid by the access logic 10, the computer 2 proceeds on to step 4.18 and enables unrestricted access by the controller 12 to the entire partitioned memory 8 for use in computational processes, to include communications processing.

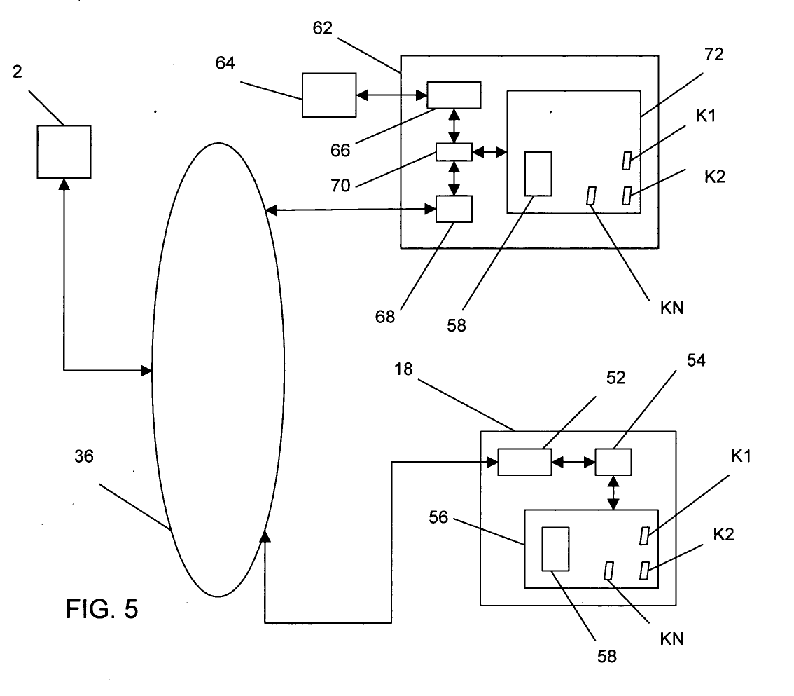

Referring now generally to the Figures and particularly to FIG. 5, FIG. 5 is an illustration of an electronic communications network 36 comprising the computer 2 of FIG. 3 and the server 18, the server 18 enabling access to the partitioned memory 8 of the computer 2. The electronic communications network 36 may comprise the Internet, an intranet, and/or an extranet. The server 18 includes a server network interface 52, a controller 54 and a server memory 56. The server network interface 52 is bi-directionally communicatively coupled to both the electronics communications network 36 and the controller 54. The controller 54 is bi-directionally communicatively coupled to the server memory 56. The server memory 56 includes a purchase processing software 58 and the key K1 as well as a plurality of segment keys K2-KN. The use of the plurality of segment keys K2-KN is discussed below in reference to FIG. 8.

In accordance with the first method, the server 18 may receive a purchase request from the computer 2 as per step 4.12 of FIG. 4. The purchase request received from the computer 2 and by the server 18 may include a credit, debit or bank account identification that is processed by the purchasing processor software 58. The server 18 may communicate with other servers 60 of the electronics communications network 2 in the execution of the purchase processing software 58, e.g., confirming that a server 60 of a financial institution will provide a payment from an account referenced in the purchase request as received by the server 18.

The computer 2 may alternatively or additionally be in communication with a wireless telephony network device 62. The wireless telephony network device 62 is bi-directionally communicatively coupled with both the (a.) computer 2 via a wireless server transponder 64; and (b.) the server 18 via the electronics communications network 36.

The wireless telephony network device 62 includes the wireless server transponder 64, a wireless device interface circuit 66, a wireless network device interface 68, a wireless device controller 70 and a wireless device memory 72. The wireless device controller 70 is bi-directionally communicatively coupled to (a.) the wireless device interface circuit 66, (b.) the wireless network device interface 68; (c.) the wireless device memory 72. The wireless device interface circuit 66 is bi-directionally communicatively coupled to both the wireless server transponder 64 and the wireless device controller 70. The wireless telephony network device 62 is bi-directionally communicatively coupled to both the electronic communications network 36 and the wireless device controller 70.

The wireless telephony network device 62 may access the server memory 56 via the wireless network device interface 68 and the electronic communications network 36 to complete a purchase request by the user and receive a key K1-KN from the server 18, and thereupon transmit the received key K1-KN to the computer 2. Alternatively or additionally, the wireless device memory 72 includes a purchase processing software 58 and the key K1 as well as a plurality of segment keys K2-KN. The use of the plurality of segment keys K2-KN is discussed below in reference to FIG. 8.

In accordance with the first method, the wireless telephony network device 62 may receive a purchase request from the computer 2 via a wireless message transmission from the wireless communications transponder 38 in accordance with step 4.12 of FIG. 4.

The user's purchase request transmitted by the computer 2 step 4.12 of FIG. 4 and received by the wireless telephony network device 62 may include a credit, debit or bank account identification that is processed by the purchasing processor software 58. The wireless telephony network device 62 may communicate with other servers 60 of the electronics communications network 2 in the execution of the purchase processing software 58, e.g., confirming that a server 60 of a financial institution will provide a payment from an account referenced in the purchase request as received by the wireless telephony network device 62.

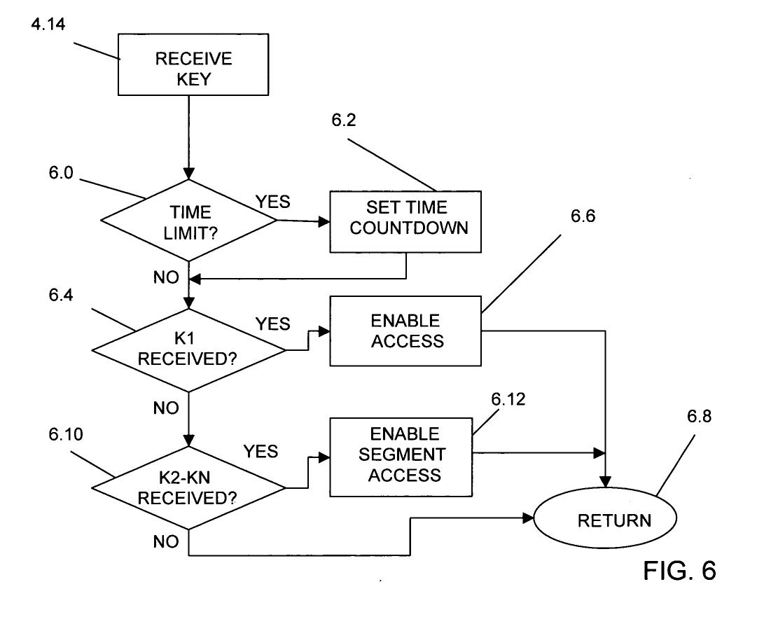

Referring now generally to the Figures and particularly to FIG. 6, FIG. 6 is an illustration of a second alternate preferred embodiment of the method of the present invention, hereafter “second method”. Proceeding from step 4.14, a second software program 74 in accordance with the second method directs the computer 2 to implement the access logic 10 to determine whether a time limit shall be set for access to the partitioned element 8. When the access logic 10 to determines in step 6.0 to set a time limit for access to the partitioned element 8, the computer 2 initiates a countdown to limit the time duration of access to the partitioned memory 8. In step 6.4 the access logic 10 determines whether the key K1-KN received in step 4.14 is the key K1 that enables access to the entire partitioned memory 8. When the access logic 10 determines in step 6.4 that the key K1-KN received in step 4.14 is the key K1, the computer 2 proceeds on to step 6.6 and enables access to the entire partitioned memory 8. The computer 2 proceeds from step 6.6 to step 6.wherefrom the controller 12 has unrestricted access by to the entire partitioned memory 8 for use in computational processes, to include communications processing. In step 6.10 the access logic 10 determines whether the key or keys K1-KN received in step 4.14 includes a key K2-KN that enables access one or more partitioned memory segments 8A-8N. When the access logic 10 determines in step 6.10 that the key or keys K 1 -KN received in step 4.14 includes a key K2-KN that enables one or more partitioned memory segments 8A-8X, the computer 2 proceeds on to step 6.12 and enables access to the relevant partitioned memory segment or segments 8A-8X associated with the key or keys K1-KN received in step 4.14. The computer 2 proceeds from step 6.12 to step 6.14 wherefrom the controller 12 has unrestricted access by to the partitioned memory segments 8A-8X as enabled in step 6.12 and for use in computational processes, to include communications processing

The term “computer-readable medium” as used herein refers to any suitable medium known in the art that participates in providing instructions to the network for execution. Such a medium may take many forms, including but not limited to, non-volatile media, volatile media, and transmission media. Non-volatile media includes, for example, optical or magnetic disks, tapes and thumb drives. Volatile media includes dynamic memory. Transmission media includes coaxial cables, copper wire and fiber optics. Common forms of computer-readable media include, for example, a floppy disk, a flexible disk, hard disk, magnetic tape, or any other magnetic medium, a CD-ROM, any other optical medium, RAM, a PROM, and EPROM, a FLASH-EPROM, any other memory chip or cartridge, or any other suitable medium known in the art from which a computer can read machine executable instructions.

Various forms of computer readable media may be involved in carrying one or more sequences of one or more instructions to the network for execution. For example, the instructions may initially be carried on a magnetic disk of a remote computer. The remote computer can load the instructions into its dynamic solid-state electronic memory 8 and send the instructions over a telephone line using a modem. A modem local to or communicatively linked with the network can receive the data on the telephone line and use an infrared transmitter to convert the data to an infrared signal. An infrared detector can receive the data carried in the infrared signal and appropriate circuitry can provide the data to the network.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

What is claimed is:

1. A computer configurable for exchanging information via an electronics-communications, the computer comprising:
a controller;
a memory, the memory bi-directionally communicatively coupled with the controller, and the memory comprising an open area and a partitioned area, the open area available for use by the controller; and
an access logic, the access logic bi-directionally communicatively coupled with the controller and configured to enable access to the partitioned to the controller after a receipt by the access logic of an access purchase confirmation.

2. The computer of claim 1 further comprising a network interface module, the network interface module bi-directionally communicatively coupling the controller with an electronics communications network, whereby the access purchase confirmation may be delivered via the network interface module and to the access logic.

3. The computer of claim 2, wherein the communications network is selected from the group consisting of the Internet, an intranet, an extranet, a computer network, and a telephony system.

4. The computer of claim 1 further comprising a user interface module, the user interface module bi-directionally communicatively coupled with the controller, whereby the access purchase confirmation may be delivered via the user interface module.

5. The computer of claim 4 further comprising a network interface module, the network interface module bi-directionally communicatively coupling the controller with an electronics communications network, whereby the access purchase confirmation may be delivered via the network interface module and to the access logic.

6. The computer of claim 1, further comprising an application software, the application software comprising the access logic.

7. The computer of claim 1, further comprising a logic device, the logic device comprising the access logic.

8. A method for enabling access to an additional capacity of a memory of a computer by a server, the server bi-directionally communicatively coupled with the computer, the method comprising:
reception by the server of an authorization for the computer to enable access to the additional capacity of the memory; and
transmitting an access command to a controller of the computer to enable access to the additional capacity of the memory by the computer.

9. The method of claim 8, wherein the server and the computer are bi-directionally communicatively coupled by an electronics communications network selected from the group consisting of the Internet, an intranet, an extranet, a computer network and a telephony system.

10. The method of claim 8, wherein the computer further comprises a user input module, the user interface module bi-directionally communicatively coupled with the controller, wherein authorization for the computer to enable access to the additional capacity of the memory may be delivered via the user interface module; and the access command to the controller of the computer to enable access by the computer to the additional capacity of the memory may be derived from the authorization by the computer.

11. The method of claim 8, wherein when the computer is purchased the controller is enabled to access a primary area of the memory.

12. The method of claim 11, wherein the computer is advertised for sale as providing access to the primary area of memory.

13. The method of claim 8 wherein the user is informed when the computer's operation is degraded by delays due to a memory capacity constraint.

14. The method of claim 8, wherein the access command enables access to a first portion of the additional capacity of the memory by the computer.

15. The method of claim 8, wherein the access command enables access to a second and separate portion of the additional capacity of the memory by the computer.

16. The method of claim 8, wherein the access command enables temporary access to a first portion of the additional capacity of the memory by the computer.

17. The method of claim 16, wherein the access command enables temporary access period is for no more than ninety days from receipt of the access command by the computer.

18. The method of claim 16, wherein the access command may be issued by the controller when the computer requires more memory than the primary area; a user is notified by the computer that access to additional capacity of the memory is limited to a set time period; and the user is informed about how to purchase access rights to the additional capacity of the memory.

19. The method of claim 18, wherein the access command is issued by the controller upon a first occasion after purchase and delivery that the computer requires more memory than the primary area.

20. The method of claim 18, wherein the access rights to the additional capacity of the memory is available for purchase at a discounted price for a set time period after the access command is issued in response to a determination by the computer that the computer requires more memory than the primary area.

21. The method of claim 16, wherein the access code may be issued by the controller upon a first occasion that the computer's operation is degraded by delays due to a memory capacity constraint.

22. The method of claim 21, wherein a user is notified by the computer that access to the additional capacity of the memory is limited to a set time period; and the user is informed about how to purchase access rights to the additional capacity of the memory.

23. A computer-readable media comprising software-encoded instructions that direct an information technology network to practice the method of claim 8.
